(19) United States
(12) Patent Application Publication
(10) Pub. No.: US 2025/0321538 A1
(43) Pub. Date: Oct. 16, 2025

(54) HOROLOGICAL RESONATOR MECHANISM WITH A FLEXIBLE ROTARY GUIDE AND PROVIDED WITH RETAINING MEANS

(71) Applicant: The Swatch Group Research and Development Ltd, Marin (CH)

(72) Inventors: Dominique LECHOT, Les Reussilles (CH); Gianni DI DOMENICO, Neuchâtel (CH); Mohammad Hussein KAHROBAIYAN, Boudevilliers (CH); Jean-Jacques BORN, Morges (CH)

(73) Assignee: The Swatch Group Research and Development Ltd, Marin (CH)

(21) Appl. No.: 19/082,524

(22) Filed: Mar. 18, 2025

(30) Foreign Application Priority Data
Apr. 12, 2024 (EP) 24170095.4

(51) Int. Cl. G04B 17/10; G04B 43/00

(52) U.S. Cl. CPC G04B 17/10; G04B 43/002

(57) ABSTRACT

A horological resonator mechanism (100) including a structure (1) and an anchor unit (30) from which is suspended at least one inertial element (2) arranged to oscillate, with a first degree of rotational freedom RZ, about a pivot axis (D) extending in a first direction Z. The inertial element (2) is subjected to return forces exerted by a flexible guide (200) forming a virtual pivot, the anchor unit (30) being suspended from said structure (1) by a flexible suspension (300) arranged to allow said anchor unit (30) to move with a plurality of degrees of freedom. A retaining device (10) provides the flexible suspension (300), which is configured to damp the rotation of the inertial element (2) and of the flexible suspension (300) about the second direction X, and/or about the third direction Y.

### CROSS-REFERENCE TO RELATED APPLICATIONS

This application claims priority to European Patent Application No. 24170095.4 filed on Apr. 12, 2024, the entire contents of which are incorporated herein by reference.

### FIELD OF THE INVENTION

The invention relates to horological resonator mechanism with a flexible rotary guide and provided with retaining means.

The invention further relates to a horological movement comprising at least one such resonator mechanism.

The invention relates to the field of horological resonators, and more particularly to those that comprise resilient strips acting as return means for the running of the oscillator.

### BACKGROUND OF THE INVENTION

The torsional stiffness of the suspension is a delicate issue for most horological oscillators comprising at least one balance spring or resilient strips constituting a flexible guide, and in particular for resonators with crossed strips. Moreover, impact strength also depends on this torsional stiffness; more specifically, during impacts, the stress to which the strips are subjected quickly reaches very high values, which accordingly reduces the distance the part can travel before breaking. Numerous variations of shock absorbers for timepieces are available. However, the purpose thereof is essentially to protect the fragile pivots of the staff of the resonator, not the resilient elements, such as the balance spring in a conventional example.

New mechanism architectures make it possible to maximise the quality factor of a resonator, by using a flexible guide with the use of a lever escapement having a very small lift angle, according to the Swiss patent application No. CH15442016 filed by ETA Manufacture Horlogère Suisse and its derivatives, the teachings whereof can be directly used in the present invention, and the resonator whereof can be further improved with regard to its sensitivity to impacts, in some specific directions. The aim is thus to protect the strips from breaking in the event of an impact. It is clear that the impact protection systems proposed thus far for resonators with flexible guides protect the strips from impacts in certain directions only, and not in all directions, or that they have the drawback of allowing the setting of the virtual pivot to move slightly according to the oscillatory rotation thereof, which should be avoided as much as possible.

The Swiss patent application No. CH5182018 or the European patent application No. EP18168765 filed by ETA Manufacture Horlogère Suisse describes a timepiece resonator mechanism, comprising a structure carrying, via a flexible suspension, an anchor unit from which is suspended an inertial element oscillating with a first degree of rotational freedom RZ, under the action of return forces exerted by a virtual pivot comprising first resilient strips each fixed to said inertial element and to said anchor unit, the flexible suspension being arranged to allow the anchor unit a certain level of mobility in every degree of freedom except the first degree of rotational freedom RZ wherein only the inertial element can move to avoid any disturbance to its oscillation, and the stiffness of the suspension in the first degree of rotational freedom RZ is very considerably higher than the stiffness of the virtual pivot in this same first degree of rotational freedom RZ.

The Swiss patent application No. CH715526 or the European patent application No. EP3561607 filed by ETA Manufacture Horlogère Suisse describes a horological resonator mechanism comprising a structure and an anchor unit from which is suspended at least one inertial element arranged to oscillate with a first degree of rotational freedom RZ about a pivot axis extending in a first direction Z, said inertial element being subjected to return forces exerted by a virtual pivot comprising a plurality of substantially longitudinal resilient strips, each fixed, at a first end to said anchor unit, and at a second end to said inertial element, each said resilient strip being deformable essentially in a plane XY perpendicular to said first direction Z.

However, other spurious movements of the inertial element and the translation stages exist, in particular additional rotational movements, either about the second direction X or about the third direction Y. These spurious movements are caused by sudden movements of the timepiece, or even due to the escapement mechanism being driven by the inertial element. Current devices are unable to avoid them.

### SUMMARY OF THE INVENTION

The invention proposes improving the resonator mechanism of the Swiss patent application No. CH715526 or the European application No. EP3561607 filed by ETA Manufacture Horlogère Suisse in order to protect the flexible suspension from the aforementioned drawbacks.

To this end, the invention relates to a horological resonator mechanism comprising a structure and an anchor unit from which is suspended at least one inertial element arranged to oscillate, with a first degree of rotational freedom RZ, about a pivot axis extending in a first direction Z, said inertial element being subjected to return forces exerted by a flexible guide forming a virtual pivot, said anchor unit being suspended from said structure by a flexible suspension arranged to allow said anchor unit to move with a plurality of degrees of freedom, at least two of which lie in a plane XY, in a second direction X and in a third direction Y orthogonal to said second direction X.

The invention is characterised in that the mechanism comprises means for retaining the flexible suspension, which means are configured to damp rotation of the inertial element and of the flexible suspension about the direction X, and/or about the direction Y.

Thus, the spurious rotary movement of the suspension is damped by the resilient retaining means thereof, at least in one direction, for example in the direction X or the direction Y. Thanks to this damping, the disturbances caused to the running of the regulating member are reduced.

According to a particular embodiment of the invention, the flexible guide comprises a plurality of substantially longitudinal resilient strips, each fastened at a first end to said anchor unit, and at a second end to said inertial element, each said resilient strip being deformable essentially in the plane XY perpendicular to said first direction Z.

According to a particular embodiment of the invention, said retaining means comprise a connecting body rigidly connected to the flexible suspension, the connecting body being movable in a direction substantially perpendicular to the direction X, or respectively substantially perpendicular to the direction Y, i.e. in the direction Z.

In a particular embodiment of the invention, the connecting body comprises an arm extending from the flexible suspension.

According to a particular embodiment of the invention, said retaining means comprise a resiliently deformable damping element, arranged to attenuate the displacement of the connecting body.

According to a particular embodiment of the invention, the damping element is arranged on a first intermediate plate of the flexible suspension.

According to a particular embodiment of the invention, the connecting body extends substantially in the plane XY.

According to a particular embodiment of the invention, the damping element comprises a movable comb and an unmovable comb, as well as a dissipative liquid arranged between the movable comb and the unmovable comb.

According to a particular embodiment of the invention, the damping element comprises a spring in contact with the connecting body.

According to a particular embodiment of the invention, the spring is provided with a bent flexible strip.

According to a particular embodiment of the invention, the damping element comprises a stop, and preferably a viscous liquid.

According to a particular embodiment of the invention, the damping element comprises a resilient body, for example made of a polymer material.

According to a particular embodiment of the invention, said flexible suspension comprises, between said anchor unit and a first intermediate plate, a transverse translation stage comprising transverse strips extending in said second direction X.

According to a particular embodiment of the invention, said flexible suspension comprises a second intermediate mass and a longitudinal translation stage, the longitudinal translation stage being arranged between said anchor unit and the second intermediate mass, the longitudinal translation stage comprising longitudinal strips extending in said third direction Y, and comprises said transverse translation stage between said second intermediate mass and said first intermediate plate.

According to a particular embodiment of the invention, the mobility of said anchor unit is possible with five degrees of freedom of the flexible suspension, which are a first degree of translational freedom in said first direction Z, a second degree of translational freedom in the second direction X orthogonal to said first direction Z, a third degree of translational freedom in the third direction Y orthogonal to said second direction X and to said first direction Z, a second degree of rotational freedom RX about an axis extending in said second direction X, and a third degree of rotational freedom RY about an axis extending in said third direction Y.

The invention further relates to a horological movement comprising a resonator mechanism according to the invention.

### BRIEF DESCRIPTION OF THE DRAWINGS

Other features and advantages of the invention will be better understood upon reading the following detailed description given with reference to the accompanying drawings, in which:

FIG. 1 diagrammatically shows a perspective view of a first embodiment of a resonator mechanism with resilient strips, comprising an inertial mass suspended from an anchor unit by a flexible guide;

FIG. 2 diagrammatically shows the first embodiment of the resonator mechanism in FIG. 1, showing the retaining means according to the invention;

FIG. 3 diagrammatically shows a top view of part of the first embodiment of the resonator mechanism in FIG. 2;

FIG. 4 diagrammatically shows a top view of part of a second embodiment of the resonator mechanism according to the invention;

FIG. 5 diagrammatically shows a top view of part of a third embodiment of the resonator mechanism according to the invention; and

FIG. 6 diagrammatically shows a top view of part of a fourth embodiment of the resonator mechanism according to the invention.

### DETAILED DESCRIPTION OF THE PREFERRED EMBODIMENTS

The invention relates to a horological resonator mechanism, which constitutes an alternative to the resonators described in the Swiss patent application No. CH5182018, or in the European patent application No. EP18168765 filed by ETA Manufacture Horlogère Suisse, incorporated herein by reference, a person skilled in the art knowing how to combine the features thereof with those specific to the present invention.

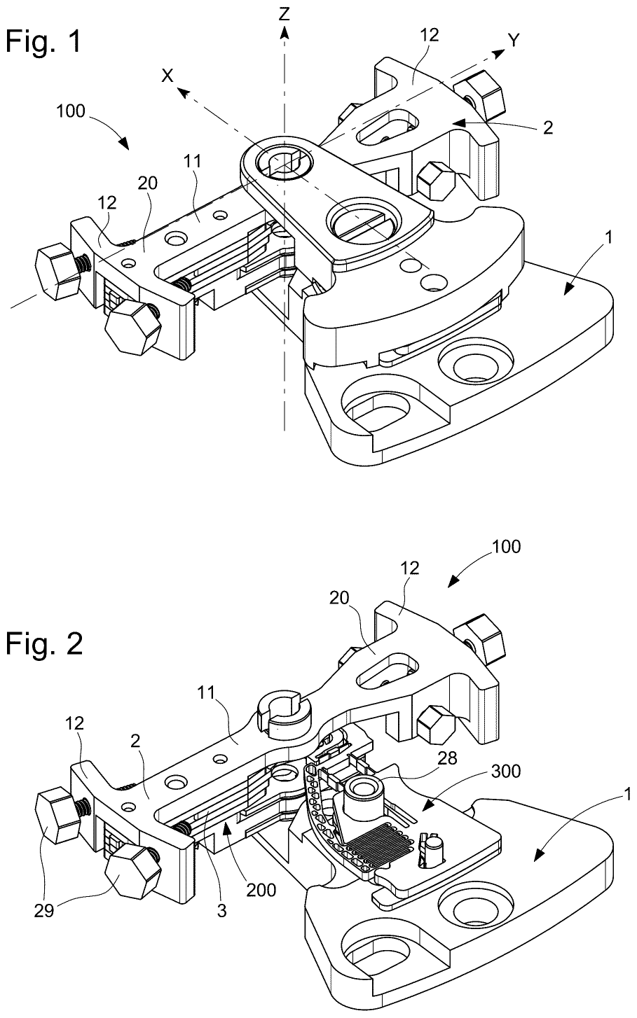

As shown in FIGS. 1 to 3, this horological resonator mechanism 100 comprises a structure 1 and an anchor unit 30, from which is suspended at least one inertial element 2 arranged to oscillate with a first degree of rotational freedom RZ about a pivot axis D extending in a first direction Z. The inertial element 2 comprises a balance 20. The balance 20 is bone-shaped and comprises a straight segment 11 provided with a bulb 12 at each end. Each bulb 12 can include small inertia blocks 29 to adjust the inertia of the inertial element 2. This inertial element 2 is subject to return forces exerted by a flexible guide 200 forming a virtual pivot.

The flexible guide 200 comprises a plurality of substantially longitudinal resilient strips 3, in this case two resilient strips 3, each fastened at a first end to the anchor unit 30, and at a second end to the inertial element 2. Each resilient strip 3 is deformable essentially in a plane XY perpendicular to the first direction Z.

The anchor unit 30 is suspended from the structure 1 by a flexible suspension 300, which is arranged to allow the anchor unit 30 to move in five flexible degrees of freedom of the suspension which are:
a first degree of translational freedom in the first direction Z,
a second degree of translational freedom in a second direction X orthogonal to the first direction Z,
a third degree of translational freedom in a third direction Y orthogonal to the second direction X and to the first direction Z,
a second degree of rotational freedom RX about an axis extending in the second direction X, and
a third degree of rotational freedom RY about an axis extending in the third direction Y.

The anchor unit 30 is mounted inside a first U-shaped intermediate mass 304.

The principle is to use the torsional flexibility of a translation stage to better manage the torsional stiffnesses of the suspension. This is achieved by orienting the strips of the XY stages so that the direction of greatest torsional flexibility is towards the axis of rotation of the resonator.

Thus, the flexible suspension 300 comprises, between the anchor unit 30 and a first intermediate plate 303, which is attached to the structure 1 in the first direction Z, a transverse translation stage 32, which comprises transverse strips 320, which are preferably rectilinear and which extend in the second direction X.

As illustrated by the figures, the flexible suspension 300 further comprises, between the anchor unit 30 and a second intermediate mass 305, a longitudinal translation stage 31, which comprises two longitudinal strips 310, which are preferably rectilinear and which extend in the third direction Y. The longitudinal strips 310 connect the ends of the U to the second intermediate mass 305, by running along the sides of the U.

The second intermediate mass 305 is elbow-shaped, which elbow is preferably substantially perpendicular, with the two longitudinal strips 310 being mounted on the same inner side of a first arm of the elbow.

Moreover, between the second intermediate mass 305 and the first intermediate plate 303, the transverse translation stage 32 comprises two transverse strips 320, preferably rectilinear and extending in the second direction X. The transverse strips 320 are thus substantially perpendicular to the longitudinal strips 310.

The two transverse strips 320 connect the same outer side of a second arm of the elbow to the first intermediate plate 303.

The first intermediate plate 303 is intended to be mounted on the structure 1.

The first intermediate plate 303 further comprises an opening 33 through which a blom stud 28 for a screw can pass.

According to the invention, the resonator mechanism 100 comprises retaining means 10 for the flexible suspension 300, which are configured to damp the rotation of the inertial element 2 and of the flexible suspension 300 about the second direction X, and/or about the third direction Y.

In the figures, the retaining means 10 of the flexible suspension 300 are configured to damp the rotation of the flexible suspension 300 about the second direction Y.

Alternatively, the retaining means 10 of the flexible suspension 300 could be configured to damp the rotation of the flexible suspension 300 about the second direction X, by modifying the direction of movement of the retaining means 10.

The retaining means 10 comprise a connecting body 13 for connecting the flexible suspension 300 to the first intermediate plate 303. The connecting body 13 is rigidly connected to the flexible suspension 300, and is movable in a direction substantially perpendicular to the third direction Y or, respectively, to the second direction X. Thus, the connecting body 13 moves in the first direction Z in the embodiment shown in the figures.

In this case, the connecting body 13 takes the form of an arm extending from the flexible suspension 300 towards the first intermediate plate 303. The connecting body 13 connects the second intermediate mass 305 to one side of the first intermediate plate 303. The arm is substantially curved to run along the side of the first intermediate plate 303 from the end of the second intermediate mass 305.

Preferably, the connecting body 13 extends in the same plane as that of the flexible suspension 300.

Said retaining means 10 further comprises a resiliently deformable damping element 15 arranged to attenuate and damp the movement of the connecting body 13.

The damping element 15 is arranged between the connecting body 13 and the first intermediate plate 303. For example, the damping element 15 is arranged partly at the end of the arm of the connecting body 13, and on the first intermediate plate 303.

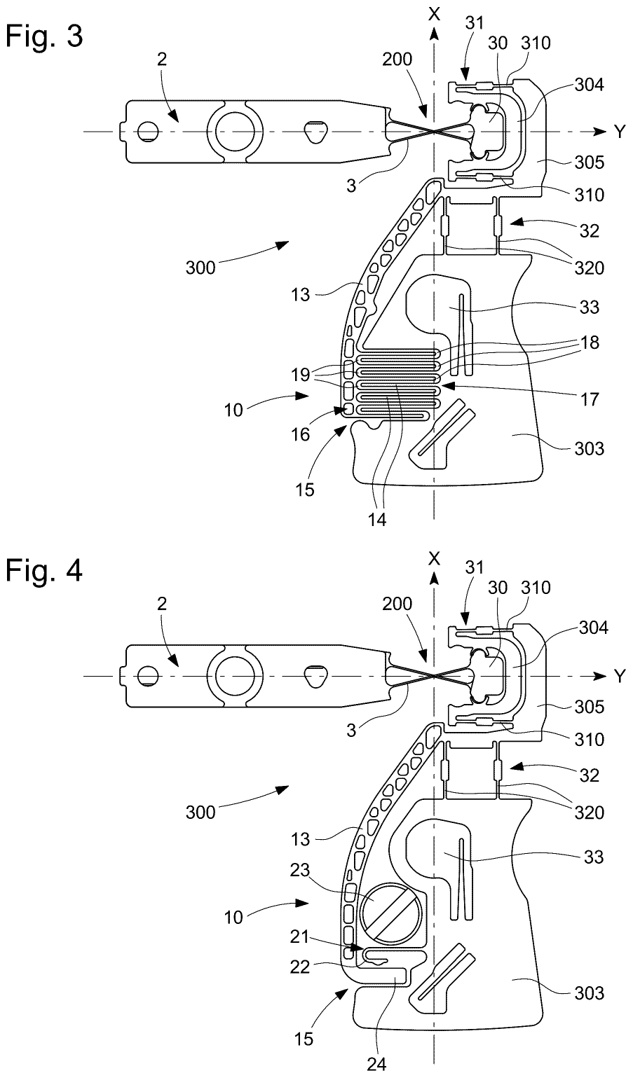

In a first embodiment, shown in FIGS. 2 and 3, said damping element 15 comprises a movable comb 16 arranged on the connecting body 13 and an unmovable comb 17 mounted on the structure 1. The movable comb 16 and the unmovable comb 17 are arranged facing one another in the same plane, and are nested one inside the other. Each comb 16, 17 comprises a plurality of teeth 18, 19. Each tooth 18 of the movable comb 16 is arranged between two teeth 19 of the unmovable comb 17, and vice versa.

The movable comb 16 extends laterally from the arm towards the first intermediate plate 303. The unmovable comb 17 is formed in the first intermediate plate 303. The combs 16, 17 also extend in the plane of the first intermediate plate 303. Thus, the movable comb 16 moves in the first direction Z.

Preferably, the damping element 15 further comprises a dissipative liquid 14 arranged between the teeth 18 of the movable comb 16 and the teeth 19 of the unmovable comb 17. Thus, when the movable comb 16 moves relative to the unmovable comb 17, the movement is partially attenuated by the dissipative liquid 14. The dissipative liquid is glycerol, for example.

In the second embodiment, the damping element 15 comprises a spring 21 mounted on the first intermediate plate 303, the connecting body 13 bearing against the spring 21, when the latter is actuated according to the additional rotation modes. The end 24 of the arm of the connecting body 13 is bent to bear against the spring, which extends perpendicularly to the first intermediate plate 303. The spring 21 is provided with a flexible strip bent at its end 22 to form a hook shape and extending from the structure 1. The spring 21 prevents or reduces the rotation of the inertial element 2 by friction against the end 24 of the arm of the connecting body 13. More specifically, as the end 24 of the arm is in contact with the spring 21, the end 24 is hindered in its movement in the direction Z.

Preferably, an eccentric 23 is also arranged against the spring to hold it in position and prevent it from moving under the effect of the movement of the connecting body 13. Thus, only the bent end 22 of the spring 21 is used to damp the movement of the connecting body 13.

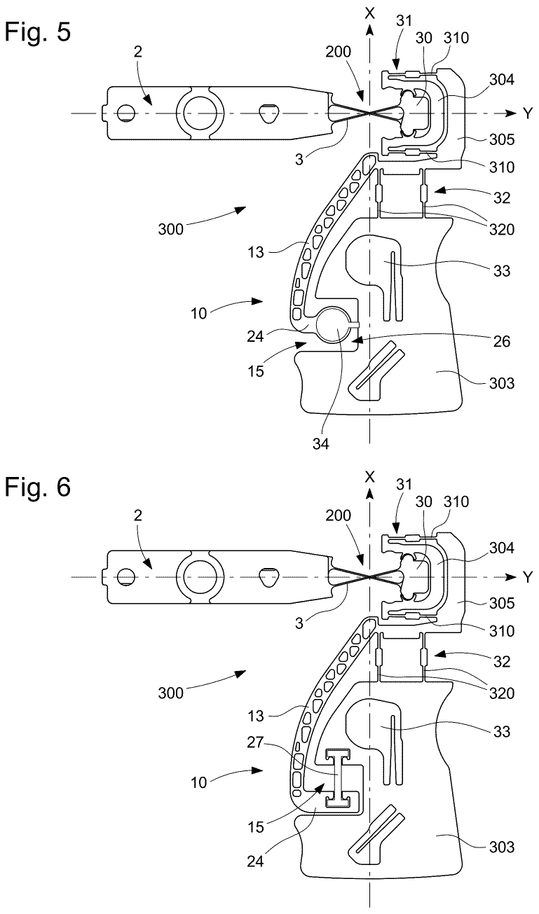

The third embodiment shown in FIG. 5 describes a connecting body 13 comprising an arm, the bent end 24 whereof forms a protrusion, in this case rounded into the shape of a disc. The end 24 of the connecting body 13 is inserted into a cavity 26 formed through the first intermediate plate 303. A stop 34 is arranged above the protrusion of the end 24 to prevent displacement of the end 24 in the direction Z, and thus rotation of the inertial element 2 about the second direction Y. The end 24 and the stop 34 are spaced apart by a predetermined distance.

In one alternative embodiment, the stop could be arranged below the end 24. The stop 34 is also disc-shaped, for example, and the stop 34 is rigidly connected to the first intermediate plate 303 by being directly or indirectly assembled thereto. The end 24 moves in the cavity 26 in the first direction Z.

Preferably, a viscous liquid is arranged between the end 24 of the connecting body 13 and the stop 34 by adhesion, to partially absorb the energy due to the displacement of the connecting body. Thus, if the connecting body 13 and its end 24 move in the cavity 26 in the first direction Z, this movement is damped by the viscous liquid and the stop 34. Glycerol, for example, can be used as a viscous liquid for this embodiment, or a grease used in the watchmaking industry.

In the example shown in FIG. 5, the viscous liquid is arranged and retained between the two discs, that of the stop 34 and that of the rounded end 24.

In the fourth embodiment shown in FIG. 6, the damping element 15 comprises a resilient body 27, for example made of a polymer material, such as elastomer or polyoxymethylene. The resilient body 27 connects a bent end 24 of the arm of the connecting body 13 to the first intermediate plate 303. In this case, the resilient body 27 is bone-shaped, with each enlarged end embedded in the end 24 and in the first intermediate plate 303.

Thus, when the connecting body 13 moves relative to the first intermediate plate 303, the resilient body 27 deforms, in this case in the first direction Z, to absorb some of the energy and to retain the movement of the connecting body 13.

The invention further relates to a horological movement comprising at least one such resonator mechanism 100.

1. A horological resonator mechanism (100) comprising a structure (1) and an anchor unit (30) from which is suspended at least one inertial element (2) arranged to oscillate, with a first degree of rotational freedom RZ, about a pivot axis extending in a first direction Z, said inertial element (2) being subjected to return forces exerted by a flexible guide (200) forming a virtual pivot, said anchor unit (30) being suspended from said structure (1) by a flexible suspension (300) arranged to allow said anchor unit (30) to move with a plurality of degrees of freedom, at least two of which lie in a plane XY, in a second direction X and in a third direction Y orthogonal to said second direction X, wherein the horological resonator mechanism (100) comprises retaining means (10) for the flexible suspension (300), which are configured to damp the rotation of the inertial element (2) and of the flexible suspension (300) about the second direction X, and/or about the third direction Y.

2. The resonator mechanism (100) according to claim 1, wherein the flexible guide comprises a plurality of substantially longitudinal resilient strips (3), each fastened at a first end to said anchor unit (30), and at a second end to said inertial element (2), each said resilient strip (3) being deformable essentially in the plane XY perpendicular to said first direction Z.

3. The resonator mechanism (100) according to claim 1, wherein said retaining means (10) comprise a connecting body (13) rigidly connected to the flexible suspension (300), the connecting body (13) being movable in the first direction Z.

4. The resonator mechanism (100) according to claim 3, wherein the connecting body (13) comprises an arm extending from the flexible suspension (300).

5. The resonator mechanism (100) according to claim 3, wherein said retaining means (10) comprise a resiliently deformable damping element (15) arranged to attenuate the displacement of the connecting body (13).

6. The resonator mechanism (100) according to claim 5, wherein the damping element (15) is arranged on a first intermediate plate (303) of the flexible suspension (300).

7. The resonator mechanism (100) according to claim 5, wherein the damping element (15) comprises a movable comb (16) and an unmovable comb (17).

8. The resonator mechanism (100) according to claim 7, wherein the damping element (15) comprises a dissipative liquid (14) arranged between the movable comb (16) and the unmovable comb (17).

9. The resonator mechanism (100) according to claim 5, wherein the damping element (15) comprises a spring (21) in contact with the connecting body (13).

10. The resonator mechanism (100) according to claim 9, wherein the spring (21) is provided with a bent flexible strip (22).

11. The resonator mechanism (100) according to claim 5, wherein the damping element (15) comprises a stop (34), and preferably a viscous liquid.

12. The resonator mechanism (100) according to claim 5, wherein the damping element (15) comprises a resilient body (27), for example made of a polymer material.

13. The resonator mechanism (100) according to claim 1, wherein the connecting body (13) extends substantially in the plane XY.

14. The resonator mechanism (100) according to claim 1, wherein said flexible suspension (300) comprises, between said anchor unit (30) and a first intermediate plate (303), a transverse translation stage (32) comprising transverse strips extending in said second direction X.

15. The resonator mechanism (100) according to claim 14, wherein said flexible suspension (300) comprises a second intermediate mass (305) and a longitudinal translation stage (31), the longitudinal translation stage (31) being arranged between said anchor unit (30) and the second intermediate mass (305), the longitudinal translation stage (31) comprising longitudinal strips extending in said third direction Y, and comprises said transverse translation stage (32) between said second intermediate mass (305) and said first intermediate plate (303).

16. The resonator mechanism (100) according to claim 1, wherein the mobility of said anchor unit (30) is possible with five degrees of freedom of the flexible suspension, which are a first degree of translational freedom in said first direction Z, a second degree of translational freedom in the second direction X orthogonal to said first direction Z, a third degree of translational freedom in the third direction Y orthogonal to said second direction X and to said first direction Z, a second degree of rotational freedom RX about an axis extending in said second direction X, and a third degree of rotational freedom RY about an axis extending in said third direction Y.

17. A horological movement comprising at least one resonator mechanism (100) according to claim 1.
